(19) United States
(12) Patent Application Publication
(10) Pub. No.: US 2020/0300349 A1
(43) Pub. Date: Sep. 24, 2020

(54) CAMSHAFT ASSEMBLY SUPPORT STRUCTURE

(71) Applicant: OTICS CORPORATION, Aichi (JP)

(72) Inventor: Manabu SHIBATA, Nishio-shi (JP)

(21) Appl. No.: 16/793,707

(22) Filed: Feb. 18, 2020

(30) Foreign Application Priority Data
Mar. 18, 2019 (JP) 2019-049714
Nov. 5, 2019 (JP) 2019-200595

(51) Int. Cl. F16H 53/02

(52) U.S. Cl. CPC F16H 53/025; F01L 2001/0476

(57) ABSTRACT

A camshaft assembly support structure includes two camshaft assemblies including two shafts parallel to each other and cam pieces fitted on an outer surface of each of the two shafts, support members independent from each other and each including two bearings receiving the two shafts, the bearings each having a bearing surface seamless over an entire inner circumference, and positioning members each having a through hole receiving and tightly holding the shaft. The positioning members are positioned on both sides of each of the support members to position the support members in the axial direction of the shafts with the shafts being received in the bearings.

### CROSS REFERENCE TO RELATED APPLICATION

This application claims priority from Japanese Patent Applications No. 2019-049714 filed on Mar. 18, 2019 and No. 2019-200595 filed on Nov. 5, 2019. The entire contents of the priority application are incorporated herein by reference.

### TECHNICAL FIELD

The present invention relates to a camshaft assembly support structure.

### BACKGROUND

A known camshaft assembly support structure (hereinafter, a support structure) includes a camshaft assembly and a support member supporting the camshaft assembly. In the support structure of this type, the support member includes multiple bearings (journal bearings) that support the journals of the camshaft assembly. The camshaft assembly is supported by the multiple bearings arranged in the axial direction. For example, Japanese Unexamined Patent Application Publication No. 2008-157062 describes a support member of this type. The support member is a solid (single) member in which each of the bearing holes, which receive a journal, has a seamless inner surface over the entire circumference. In the solid support member, the shaft center is less likely to be displaced and a lubricant oil is more likely to be uniformly distributed over the inner surface of the bearing than in a support member including a bearing constituted of separate upper and lower portions. The support structure is eventually fixed to a cylinder head of an internal combustion engine, for example, by bolting.

### SUMMARY

In the support member of the known technology, bearings are connected to each other by a frame located around the bearings and are arranged in lines. When a camshaft assembly is attached to the support member, multiple cam pieces need to be fixed to the shaft at the same time, for example, by shrink-fitting, with the shaft of the camshaft assembly being received by the bearing of the support member. Thus, it is difficult to attach the camshaft to the known support member. Furthermore, the frame of the support member may limit the space for the attachment operation of the cam pieces to the shaft. For example, when the cam pieces are fixed to the shaft by shrink-fitting, it may be difficult to position a jig for holding the cam piece near the bearing.

An object of the technology described herein is to provide a camshaft assembly support structure including a camshaft assembly and a support member that are readily assembled.

A camshaft assembly support structure includes two camshaft assemblies, support members, and positioning members. The camshaft assemblies include two shafts parallel to each other and multiple cam pieces fitted on outer surfaces of the shafts. The support members are independent from each other. The support members include bearings having bearing surfaces. Each of the support members includes two of the bearings receiving the shafts, respectively. Each of the bearing surfaces is seamless over an entire inner circumference of each of the bearings. The positioning members include through holes in which the shafts are fitted and tightly hold the shafts. The positioning members are disposed on both sides of each of the support members to position the support members in an axial direction of the shafts with the shafts being received in the bearings.

The technology described herein provides a camshaft assembly support structure including a camshaft assembly and a support member that are readily assembled.

### BRIEF DESCRIPTION OF THE DRAWINGS

FIG. 1 is a plan view illustrating a portion of a camshaft assembly support structure according to a first embodiment.

FIG. 2 is a perspective view illustrating a cam piece.

FIG. 3 is a perspective view illustrating a support member.

FIG. 4 is a perspective view illustrating a positioning member.

FIG. 5 is an explanatory view illustrating a step of assembling a camshaft assembly support structure.

FIG. 6 is an explanatory view illustrating a step of assembling the camshaft assembly support structure.

FIG. 7 is an explanatory view illustrating a step of assembling the camshaft assembly support structure.

FIG. 8 is an explanatory view illustrating a step of assembling the camshaft assembly support structure.

FIG. 9 is an explanatory view illustrating a step of attaching the camshaft assembly support structure onto a cylinder head by using a bolt.

FIG. 10 is a plan view illustrating a portion of a camshaft assembly support structure according to another embodiment.

### DETAILED DESCRIPTION

### First Embodiment

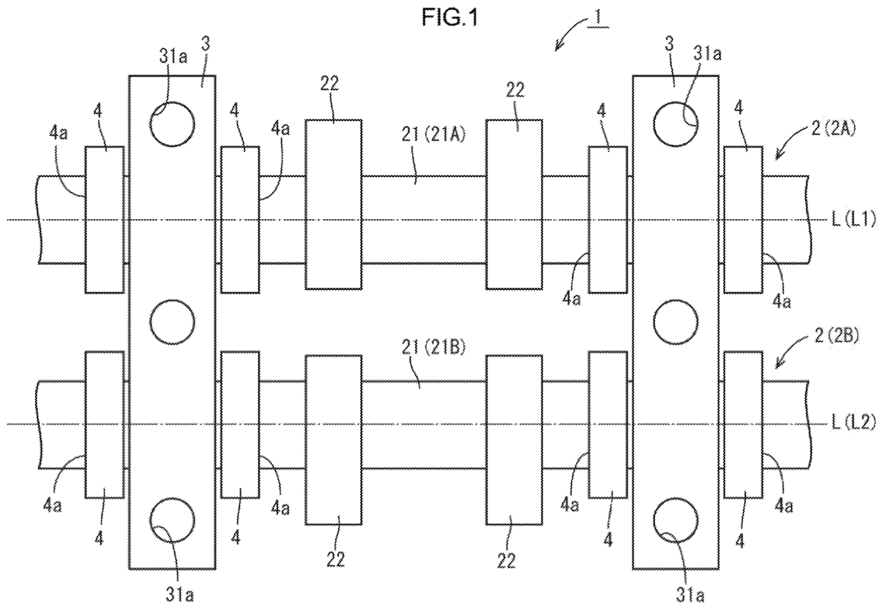

A first embodiment of the invention is described with reference to FIGS. 1 to 8. FIG. 1 is a plan view illustrating a portion of a camshaft assembly support structure 1 according to the first embodiment. A camshaft assembly support structure 1 (hereinafter, may be simply referred to as a “support structure 1”) mainly includes two camshaft assemblies 2, multiple support members 3, and multiple positioning members 4.

In this specification, in some cases, one of the camshaft assemblies 2 that is on the upper side in FIG. 1 is referred to as a “camshaft assembly 2A” (intake camshaft assembly) and the other on the lower side in FIG. 1 is referred to an “camshaft assembly 2B” (exhaust camshaft assembly).

The camshaft assembly 2 includes a shaft 21 and multiple cam pieces (cam lobes) 22 fitted on an outer surface of the shaft 21. The support structure 1 of this embodiment, which includes the two camshaft assemblies 2, includes two shafts 21 and the cam pieces (cam lobs) 22 fitted on the outer surface of each of the shafts 21. In this specification, in some cases, the shaft 21 of the camshaft assembly 2A on the upper side in FIG. 1 is referred to as a “first shaft 21A”, and the shaft 21 of the other camshaft assembly 2B on the lower side in FIG. 1 is referred to as a “second shaft 21B”.

The shaft 21 is formed by processing a metal material into a rod-like overall shape. The two shafts 21 supported by the support members 3 are arranged parallel to each other. As illustrated in FIG. 1, the cam pieces 22 on each of the shafts 21 are arranged in a direction along the axis L of the shaft 21 (axial direction). In this specification, the axis L of the first shaft 21A is referred to as an “axis L1”, and the axis L of the second shaft 21B is referred to as an “axis L2” in some cases. A portion of each of the shafts 21 supported by a bearing 32 of the support member 3 is referred to as a “journal” in some cases.

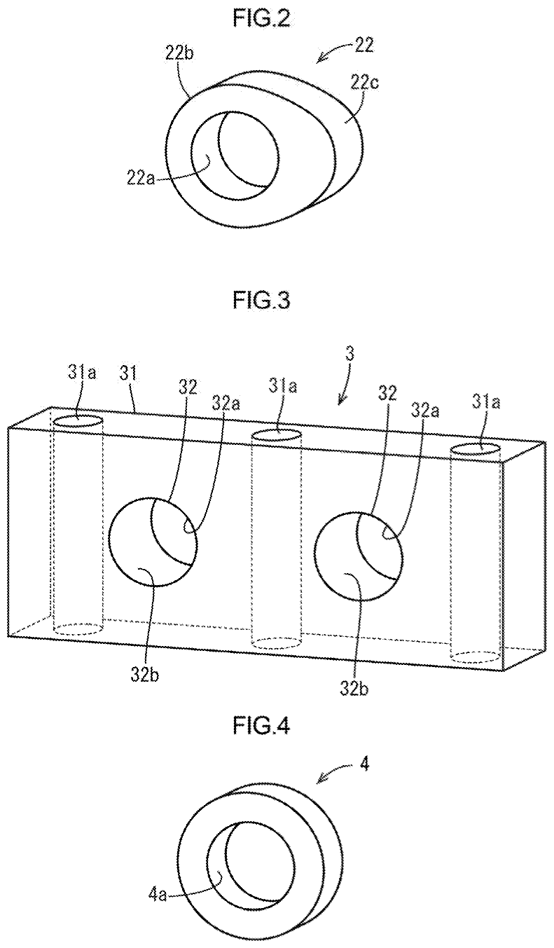

FIG. 2 is a perspective view of the cam piece 22. The cam piece 22 has a substantially oval overall shape and has a through hole 22a that receives the shaft 21. The inner diameter of the through hole 22a is substantially the same as the outer diameter of the shaft 21. The cam piece 22 has a cam base 22b having an arc-like shape concentric with the through hole 22a and a cam nose 22c in which a distance from the center of the through hole 22a to the outer edge of the cam piece 22 is longer than that in the cam base 22b. The cam piece 22 is formed by processing a metal material into a predetermined shape. The cam piece 22 is fixed to the shaft 21 by shrink-fitting with the shaft 21 being received in the through hole 22a.

FIG. 3 is a perspective view of the support member 3. The support member 3 is designed to support the two camshaft assemblies 2 and eventually fix the support structure 1 onto a cylinder head of an internal combustion engine. The support structure 1 includes multiple independent support members 3. The support members 3 are arranged in the axis L direction with a space therebetween and are each attached to the two camshaft assemblies 2. The support member 3 includes a body 31 having a flat cuboidal overall outer shape and two bearings 32 supporting the shafts 21 inserted therein, respectively. The bearings 32 include holes 32a that receive the shaft 21, respectively. The holes 32a have inner surfaces 32b. The support member 3 is obtained by processing a metal material, such as an aluminum alloy, and is a single (solid) member. The support members 3 are not connected to each other and are independent from each other.

As illustrated in FIG. 1, the body 31 supports both the two shafts 21 (camshaft assemblies 2) parallel to each other. The body 31 includes two bearings 32 arranged in a direction perpendicular to the axis L direction. Furthermore, the body 31 has bolt through holes 31a extending through the body 31 in the vertical direction. In this embodiment, the number of bolt through holes 31a is three. One of the bolt through holes 31a is located in the middle of the body 31 and the other two of the bolt through holes 31a are located at the ends of the body 31 in the direction perpendicular to the axis L direction.

The bearing 32 is a journal bearing and rotatably supports the shaft 21 (journal) with the shaft 21 (journal) being received in the hole 32a. The inner surface 32b of the hole 32a is seamless over the entire circumference.

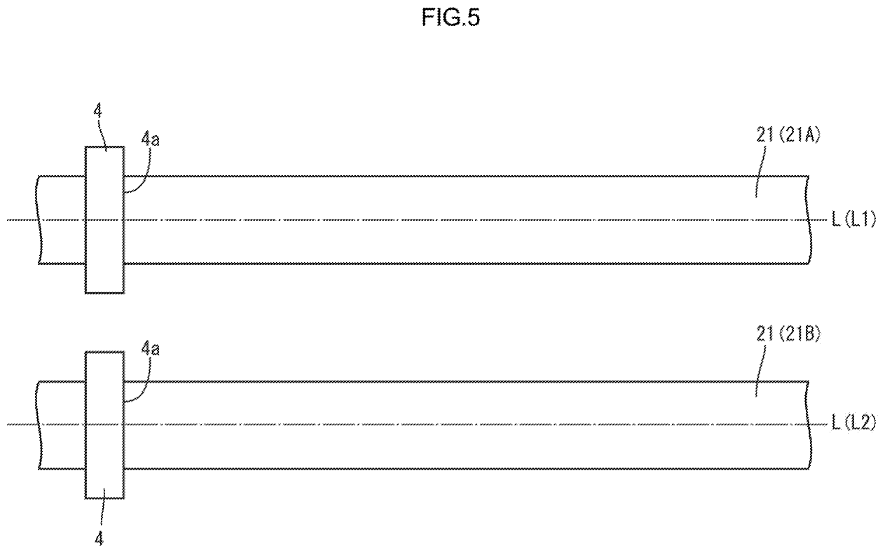

FIG. 4 is a perspective view of the positioning member 4. The positioning members 4 position the support member 3 in the axial direction (axis L direction) of the shafts 21 with the shafts 21 being received by the bearings 32. Each of the positioning members 4 has a ring-like overall shape with a hole 4a that receives the corresponding shaft 21. The inner diameter of the hole 4a is substantially the same as the outer diameter of the shaft 21. The shafts 21 are fitted in the holes 4a in the positioning members 4, and the positioning members 4 are fixed to the shafts 21 by shrink-fitting. The shafts 21 are tightly held in the holes 4a in the positioning members 4.

The support structure 1 includes multiple positioning members 4. As illustrated in FIG. 1, four positioning members 4 are used for one support member 3 to position the shafts 21 in the axial direction. For example, for the support member 3 on the left in FIG. 1, two positioning members 4 are disposed on the first shaft 21A and two positioning members 4 are disposed on the second shaft 21B.

To position the support member 3 on the left in FIG. 1 relative to the first shaft 21A, two positioning members 4 are fixed to the first shaft 21A while being arranged in a line in the axis L1 direction with the support member 3 therebetween. The positioning members 4 on the first shaft 21A are arranged on the both sides of the support member 3 with the support member 3 therebetween. Furthermore, to position the support member 3 on the left in FIG. 1 relative to the second shaft 21B, two positioning members 4 are fixed to the second shaft 21B while being arranged in a line in the axis L2 direction with the support member 3 therebetween. The positioning members 4 on the second shaft 21B are arranged on both sides of the support member 3 with the support member 3 therebetween.

In other words, two positioning members 4 are disposed adjacent to one side surface (left side in FIG. 1) of the support member 3 and two positioning members 4 are disposed adjacent to the other side surface (right side in FIG. 1) of the support member 3.

The positioning members 4 do not need to be in close contact with the support member 3. A space may be left between the support member 3 and the positioning member 4 as long as the movement of the support member 3 on the shafts 21 in the axial direction is limited to some extent. The space between the support member 3 and the positioning member 4 absorbs a dimension error when the support structure 1 is attached to a predetermined portion of a cylinder head.

Next, with reference to FIGS. 5 to 8, a method of assembling the support structure 1 (production method) is described. As illustrated in FIG. 5, in the method of assembling the support structure 1, first, one positioning member 4 is fixed to each of two shafts 21 by shrink-fitting. Specifically described, the positioning member 4 to be fixed to the first shaft 21A and the positioning member 4 to be fixed to the second shaft 21B are arranged in the direction perpendicular to the axis L direction as illustrated in FIG. 5 while each being held by a jig having a heat generator. Then, the positioning members 4 held by the jigs are each heated to increase the inner diameter of the hole 4a, and the shafts 21 at room temperature are inserted into the respective enlarged holes 4a in the positioning members 4. The positioning members 4 are positioned at predetermined portions of the shafts 21. After the insertion of the shafts 21, the positioning members 4 are brought back to room temperature. The inner diameter of the hole 4a decreases as the temperature of the positioning member 4 decreases to room temperature, and thus the inner surface of the hole 4a is closely fitted to the outer surface of the shaft 21. Thus, the positioning member 4 is fixed to a predetermined position of the shaft 21. The positions of the positioning members 4 on the shaft 21 are suitably determined depending on the position of the support member 3, which is positioned by the positioning members 4.

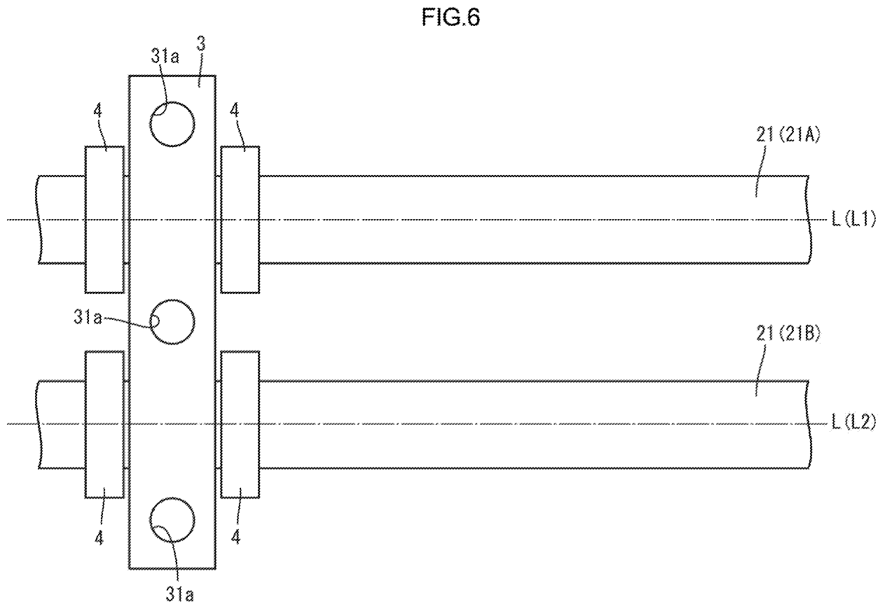

Next, as illustrated in FIG. 6, the two shafts 21 having the positioning members 4 are inserted into the two bearings 32 of the support member 3, and thus the support member 3 is attached to the two shafts 21. Then, one positioning member 4 is fixed to each of the two shafts 21 by shrink-fitting. In this way, the support member 3 is positioned between the two positioning members 4 on the first shaft 21A and positioned between the two positioning members 4 on the second shaft 21B, and thus the support member 3 is positioned in the axial direction (axis L direction) of the shafts 21.

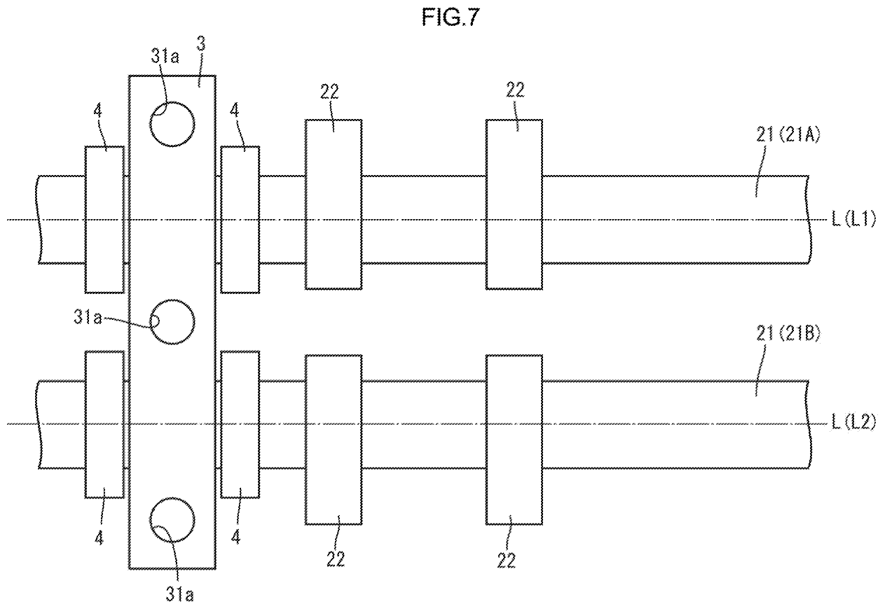

Then, as illustrated in FIG. 7, the cam pieces 22 are fixed to the shafts 21 by shrink-fitting at predetermined positions. Specifically described, two cam pieces 22 to be attached to the first shaft 21A are arranged in the axis L direction and two cam pieces 22 to be attached to the second shaft 21B are arranged in the axis L direction while each being held by a jig having a heat generator. The cam pieces 22 are each held by a jig such that the cam nose 22c faces in a predetermined direction. Then, the cam pieces 22 held by the jigs are each heated to increase the inner diameter of the through holes 22a, and the shafts 21 at room temperature are inserted into the respective enlarged through holes 22a in the cam pieces 22. The cam pieces 22 are positioned at predetermined portions of the shafts 21. After the insertion of the shafts 21, the cam pieces 22 are brought back to room temperature. The inner diameter of the through hole 22a decreases as the temperature of the cam piece 22 decreases to room temperature, and thus the inner circumferential surface of the through hole 22a is closely fitted to the outer circumferential surface of the shaft 21. Thus, the cam piece 22 is fixed to a predetermined portion of the shaft 21.

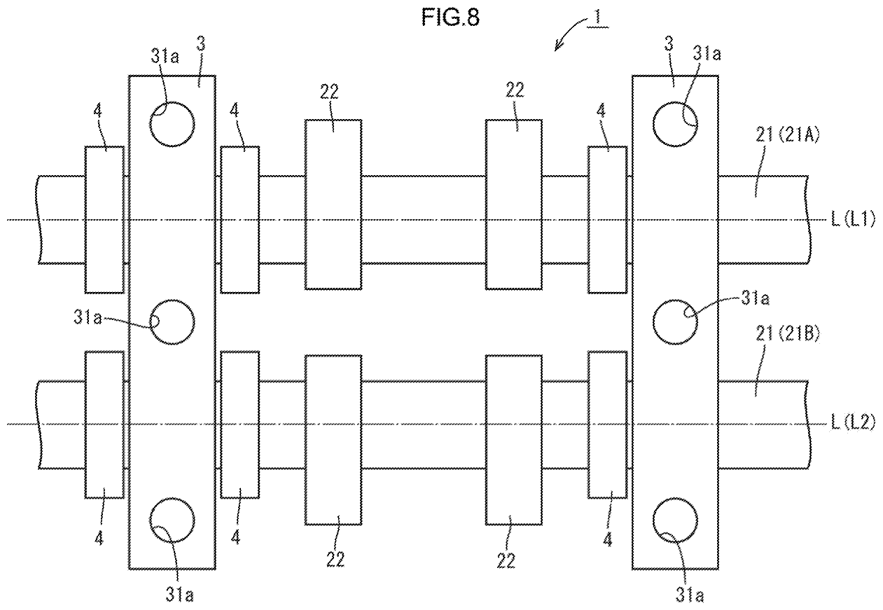

After the cam pieces 22 are attached to the shafts 21, as illustrated in FIG. 8, one positioning member 4 is attached to each of the shafts 21 by shrink-fitting. Then, another support member 3 is attached to the two shafts 21 in the same way as the above-described support member 3. Then, as illustrated in FIG. 1, one positioning member 4 is attached to each of the shafts 21.

As described above, the support structure 1 of this embodiment is produced by sequentially attaching the positioning members 4, the support member 3, the positioning members 4, the cam pieces 22, and the other components to the two shafts 21 from one end to the other end. In the support structure 1 having such a configuration, the camshaft assemblies 2 and the support members 3 are readily assembled. The support members 3 are each positioned in the axial direction of the camshaft assembly 2 (shaft 21) by the positioning members 4 positioned on the both sides of the support member 3. The support structure 1 having such a configuration is easy to transport and is also easy to eventually attach to a cylinder head.

Furthermore, in the support structure 1 of the embodiment, the support members 3 are independent from each other and not connected to each other. Thus, a space for jigs, which hold the positioning members 4 or the cam pieces 22, is readily provided around the shafts 21.

Although not illustrated in the drawings, the end portion of the shaft 21 (camshaft assembly 2) has a sprocket on which a timing belt, which transmits rotary motion of the crankshaft, is to be wound.

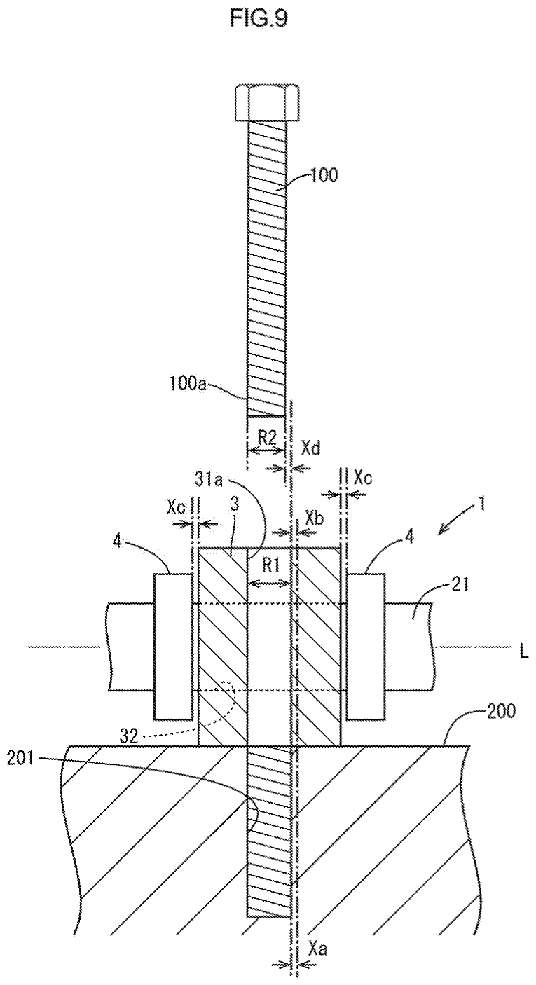

The support structure 1 of this embodiment is eventually fixed to a cylinder head by bolting. FIG. 9 is an explanatory view illustrating a process of attaching the camshaft assembly support structure 1 to a cylinder head 200 with bolts 100. Specifically described, the bolts 100 are inserted through the bolt through holes 31a in the support member 3, respectively. The bolts 100 include projecting ends 100a that project from the bolt through holes 31a are screwed into screw holes 201 in the cylinder head 200, respectively. With the bolts 100, the support structure 1 is attached to the cylinder head 200.

The diameter R1 of the bolt through hole 31a (dimension in the axis L direction in FIG. 1) may be defined in view of the followings. Here, a position error (variability) of the screw hole in the cylinder head in the axis L direction is indicated by “Xa”. Furthermore, a position error (variability) of the bolt through hole 31a in the support member 3 in the axis L direction is indicated by “Xb”. Furthermore, the space (clearance) between the support member 3 and each of the positioning members 4 on the both sides of the support member 3 in the axis L direction is indicated by “Xc”. The space (clearance) between the bolt having the diameter R2 and the bolt through hole 31a in the axis L direction is indicated by “Xd”. The relationship of “Xd>Xa+Xb+Xc” is preferably satisfied to achieve easy attachment of the support structure 1 to a cylinder head.

### Other Embodiments

The technology disclosed herein is not limited to the embodiment described above and with reference to the drawings. The following embodiments may be included in the technical scope of the present technology.

(1) In the above-described embodiment, the positioning members 4 have a ring-like shape, but the present technology is not limited to this. The positioning members 4 may have any shape that has a hole to receive the shaft and can position the support member.

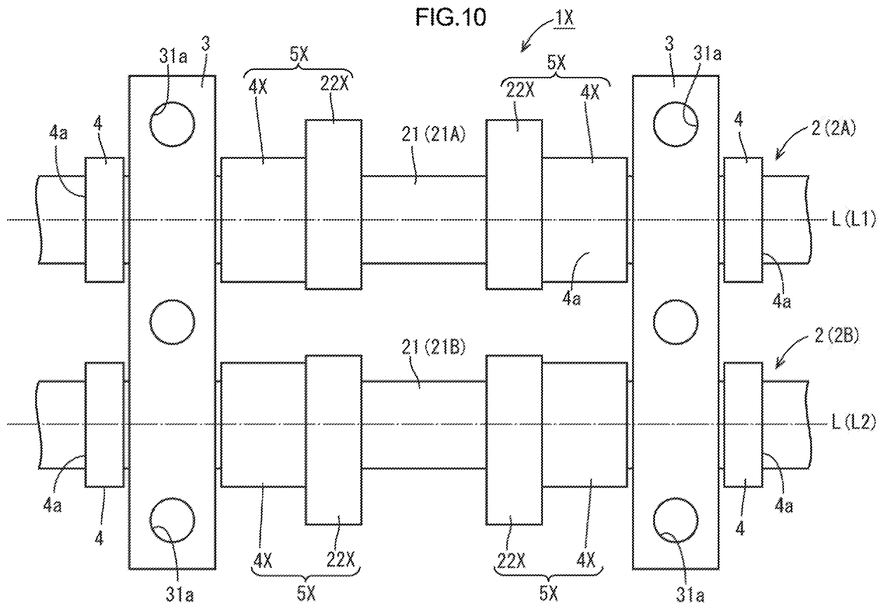

(2) In the above-described embodiment, the positioning member 4 and the cam piece 22 are different members independent from each other. However, the present technology is not limited to this configuration. In some embodiments, for example, as illustrated in FIG. 10, a cam piece 22X and a positioning member 4X adjacent to the cam piece 22X may be portions of a single solid component (a solid member 5X). The cam piece 22X may be attached to the same shaft 2 (2A or 2B). This configuration in which the cam piece 22X and the positioning member 4X are the portions of the single solid component reduces the number of parts. This may make the attachment of the cam pieces 22X and the other components to the shaft 2 (2A, 2B) easier. FIG. 10 is a plan view illustrating a portion of the camshaft assembly support structure 1X according to another embodiment. In FIG. 10, components identical to those in the first embodiment are assigned the same reference numerals as those in the first embodiment without duplicated explanation.

(3) In the above-described embodiment, the positioning members 4 are used to position the support member 3 relative to the shafts 21. However, in some embodiments, after the attachment position accuracy of the positioning members 4 on the both sides of the support member 3 in the axial direction is improved, the positioning members 4 may be used to position (cam thrust) the camshaft assembly 2 in the axial direction (axis L direction) relative to the cylinder head.

1. A camshaft assembly support structure comprising:
two camshaft assemblies including two shafts parallel to each other and a plurality of cam pieces fitted on outer surfaces of the shafts;
support members being independent from each other and including bearings having bearing surfaces, each of the support members including two of the bearings receiving the shafts, respectively, each of the bearing surfaces being seamless over an entire inner circumference of each of the bearings; and
positioning members including through holes in which the shafts are fitted and tightly holding the shafts, the positioning members being disposed on both sides of each of the support members to position the support members in an axial direction of the shafts with the shafts being received in the bearings.

2. The camshaft assembly support structure according to claim 1, wherein
the support members have bolt through holes through which bolts are inserted, and
the bolts in the bolt through holes include projecting ends that project from the bolt through holes and are to be screwed into screw holes in a cylinder head to attach the camshaft assembly support structure to the cylinder head.

3. The camshaft assembly support structure according to claim 2, wherein positions of the screws holes, positions of the bolt through holes, spaces between the support members and the positioning members on the both sides of the support members in the axial direction, and spaces between the bolts and the bolt through holes in the axial direction are defined to satisfy a relation expressed by
Xd>Xa+Xb+Xc
where Xa is a position error of each of screw holes in the axial direction of the shafts, Xb is a position error of each of the bolt through holes in the axial direction, Xc is each of the space between each of the support members and each of the positioning members on either side of the each of the support members in the axial direction, and Xd is each of the spaces between each of the bolts and corresponding one of the bolt through holes in the axial direction.

4. The camshaft assembly support structure according to claim 1, wherein each of the cam pieces fitted on the outer surfaces of the shafts and one of the positioning members adjacent to the each of the cam pieces are portions of a single solid component.
